(19) United States
(12) Patent Application Publication
(10) Pub. No.: US 2011/0154930 A1
(43) Pub. Date: Jun. 30, 2011

(54) Vessel and Method for Transferring a Force to or From Such a Vessel

(76) Inventor: Evert Hendrik Willem Zwijnenberg, Rheden (NL)

(21) Appl. No.: 12/984,494

(22) Filed: Jan. 4, 2011

Related U.S. Application Data
(63) Continuation of application No. PCT/NL2009/050390, filed on Jul. 1, 2009.

(30) Foreign Application Priority Data
Jul. 4, 2008 (NL) 2001758

(51) Int. Cl. G05G 1/00

(52) U.S. Cl. 74/469

(57) ABSTRACT

Vessel provided with a mechanism having a first arm which is positioned thereon, and a second arm having a movable extremity distant from the first arm, wherein said first arm and said second arm are connected to each other with at least one link having hinges on opposite sides of said at least one link that connect said link or links to the first arm and second arm respectively, and wherein the length of the second arm is selected so as to arrange that when the hinges on the opposite sides of said links are at the same level, the movable extremity of the second arm is level with a predetermined position within the vessel.

### CROSS-REFERENCE TO RELATED APPLICATIONS

This application is a continuation application of International Patent Application Serial No. PCT/NL2009/050390 entitled “Vessel and Method for Transferring a Force To Or From Such A Vessel”, to Evert H. W. Zwijnenberg, filed on Jul. 1, 2009, which is a continuation of Netherlands Patent Application Serial No. 2001758, entitled “Vessel and Method for Transferring a Force To Or From Such A Vessel”, to Evert H. W. Zwijnenberg, filed on Jul. 4, 2008, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention

The invention relates to a vessel provided with a mechanism having a first arm which is stationary positioned thereon, and a second arm having a movable extremity distant from the first arm, wherein said first arm and said second arm are connected to each other with a link or links having hinges on opposite sides of said link or links that connect said link or links to the first arm and second arm respectively.

2. Description of Related Art

Such a vessel is independently known from the German patent DE-C-407 225, the German patent application DE-A-26 44 881 and the Dutch patent NL-C-16 416. In these citations the mechanism is arranged such that the arms are maintained in a predetermined parallel or inclined position with respect to each other.

It is a known problem that when the vessel is subjected to a pulling force, the vessel will also be influenced in regard of its inclination in the water. The same applies when the vessel is used to apply a pushing force on another object. The vessel can for instance be a towboat; the object which is towed can be a tanker or another type of carrier. The vessel can also be a regular ship which is subjected to a pulling force that is derived from for instance a kite.

### BRIEF SUMMARY OF THE INVENTION

The invention has the objective to provide a vessel with reduced sensitivity in regard of the position it assumes in the water when the vessel exerts force on another object, or when an object exerts a force on the vessel, in both cases the forces acting via the movable extremity of the mechanism.

To that end the invention is embodied in a mechanism and vessel according to one or more of the appended claims.

### BRIEF DESCRIPTION OF THE SEVERAL VIEWS OF THE DRAWINGS

The invention shall hereinafter be further elucidated with reference to the attached drawing and without limiting the appended claims. The drawing shows in:

FIG. 1 a schematic sectional side view (FIG. 1a) and top view (FIG. 1b) of the mechanism of the invention standing on the deck of a vessel;

FIG. 2, FIGS. 3A and 3B and FIG. 4 different embodiments of the vessel of the invention, and

FIG. 5D the embodiment of FIG. 4 shown in different situations.

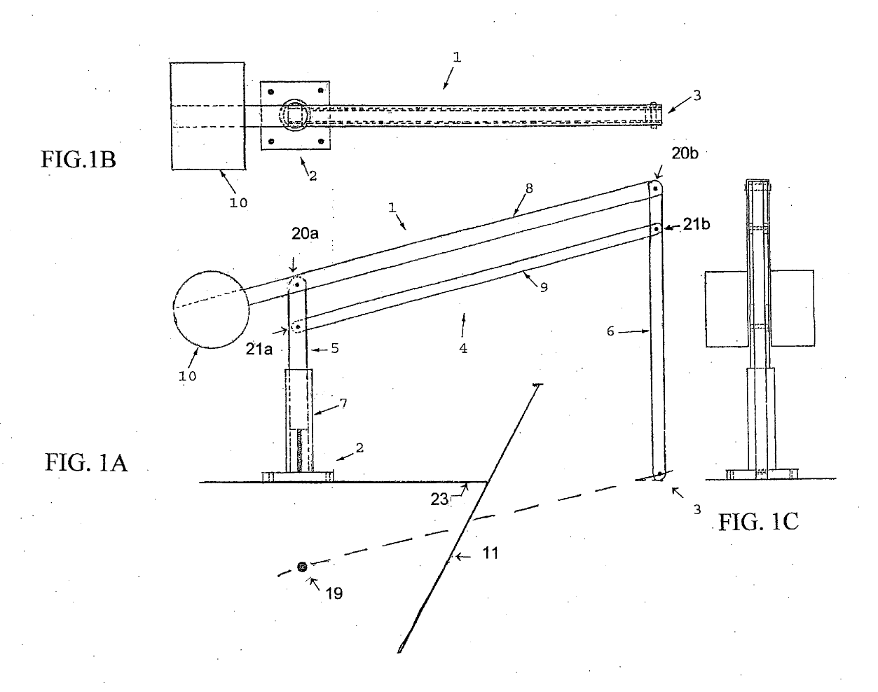

Wherever in the figures the same reference numerals are applied these numerals refer to the same parts. In order to fully comprehend the gist of the invention as specified in the claims, reference is first made to FIG. 1 showing in FIG. 1a a partly sectional side view and in FIG. 1b a partially sectional top view of the mechanism that is applied on the vessel of the invention.

### DETAILED DESCRIPTION OF THE INVENTION

The general concept of the invention is to provide a mechanism that makes it possible to have a connecting point for forces outside of a body (such as a vessel) while the acting point of the exerted forces is within said body.

In a first aspect of the invention the mechanism on the vessel has the feature that the length of the second arm is selected so as to arrange that when the hinges on the opposite sides of said links are actually or virtually at the same level (or in other words: at the same horizontal line), the movable extremity of the second arm can be level (or in other words: at the same horizontal line) with a predetermined position within the vessel. This provides the advantage that any force exerted on the vessel via the movable extremity of the second arm acts on the said predetermined position within the vessel. This tremendously reduces and can even eliminate the sensitivity of the vessel in terms of the position or inclination it occupies within the water when said force is exerted. Likewise when the vessel is used to provide a pulling force on another object, the sensitivity of the vessel to accommodate its position within the water is effectively reduced.

A further advantage is that the vessel can freely move and roll due to the prevailing conditions at sea without noticeably inducing adverse reaction-forces within the rope or cable between the vessel and the object connected to said vessel.

At particular sea conditions best results appear to be attainable when the mechanism is arranged such that the predetermined position within the vessel coincides with the vessel's center of lateral resistance. The concept of lateral resistance is commonly known among artisans; consequently a further elucidation hereof can be dispensed with.

It is further advantageous that the mechanism is rotatable around a longitudinal body axis of the first arm of the mechanism. This provides a large amount of flexibility making the orientation of the vessel of the invention less influential in regard of its sensitivity to the transfer of forces between the vessel of the invention and the object with which it is connected for the transfer of said forces.

Basically it is possible to provide the mechanism with rigid links. In order to reduce weight it may however be preferable to arrange that one or more links of the mechanism that are intended for transferring a pulling force are flexible.

It may further be desirable that the mechanism has a counterweight and/or a spring based balancing system and/or a hydraulic balancing system. This eases the practical use of the vessel of the invention in view of the fact that it avoids that additional forces are to be applied to place the mechanism into a desired position when it is not connected with an object to be pulled or pushed. The movable extremity of the second arm then remains at liberty to occupy a position that answers to the desired direction of the force to be transferred between the vessel and the connected object.

It is further preferred that the length of the first arm and/or second arm is adjustable. In this manner it is possible to vary the location of the predetermined position within the vessel on which the said forces are acting or are originating from.

The mechanism 1 has an arm 5 with an extremity 2 that is fixedly mounted on a deck 23 of a vessel 11. The mechanism 1 is further provided with a second arm 6 that has a movable extremity 3 distant from the first arm 5. The said first arm 5 and said second arm 6 are connected to each other with links 8, 9 having hinges 20a, 20b and 21a, 21b on opposite sides of said links 8, 9 that connect said links to the first arm 5, and the second arm 6 respectively. This arranges that said arms 5, 6 essentially maintain a predetermined parallel or inclined position with respect to each other corresponding with the manner that the links 8, 9 are connected to said arms 5, 6. This does not exclude the arrangement of further (not mentioned) elements in the mechanism, such as one or more shock-absorbers, which may give rise to temporary variations in the position of the second arm 6 with respect to the first arm 5.

In accordance with the invention the length of the second arm 6 is selected at a value that arranges that when the hinges 20a, 20b and 21a, 21b on the opposite sides of said links 8, 9 are at the same level, the movable extremity 3 of the second arm 6 is level with a predetermined position 19 within the vessel. In order to realize this the first arm 5 and/or the second arm 6 may have a length that is adjustable. Usually said predetermined position 19 within the vessel 11 lies below the water level. This corresponds to what is shown in FIG. IA: when the movable extremity 3 of the second arm 6 is level with the extremity 2 of the first arm 5 that is mounted on the deck 23 of the vessel, the links 8, 9 are inclined in a manner that they are parallel with a virtual line extending between the movable extremity 3 of the second arm 6 and said predetermined position 19 within the vessel, which is generally below deck level 23. This virtual line is shown as a dashed line in FIG. 1a. This arrangement secures the object of the invention, being to provide a mechanism that makes it possible to have a connecting point for forces outside of a body (the vessel) while the acting point of the exerted forces is within the body (the vessel).

The inventor remarks that the first arm 5 that is provided on the deck 23 of the vessel may be adjustable in height, for instance with a spindle 7, so as to arrange that the length of the first arm is variable. It is also feasible that instead of, or in addition to the first arm being adjustable, it is arranged that the length of the second arm is adjustable. Further it is remarked that the mechanism 1 can rotate around the longitudinal body axis of the first arm 5. One of the links 8 may further be provided with a counterweight 10 to balance the mechanism 1 in a way that particularly the movable extremity 3 of the second arm 6 can be easily manipulated and be maintained in position without exerting excessive forces thereon, if any at all. Instead of a counterweight also a spring based balancing mechanism may be applied. Likewise it is also possible that a hydraulic balancing system is applied. These examples do not exclude the application of any other means of balancing said mechanism, including such means that the inventor has not yet considered, or that still have to be developed.

The forces to be guided via the mechanism 1 to the vessel or from the vessel via the mechanism 1 to an object (not shown) are transferred in any practical application by connecting means that may be linked to the movable extremity 3 of the second arm 6.

The mechanism 1 shown in FIG. 1 is provided with rigid links 8, 9; it is however also possible to arrange that one or more of said links 8, 9 is flexible in case it is not intended that the links are used for transferring pushing forces, but only for transferring pulling forces.

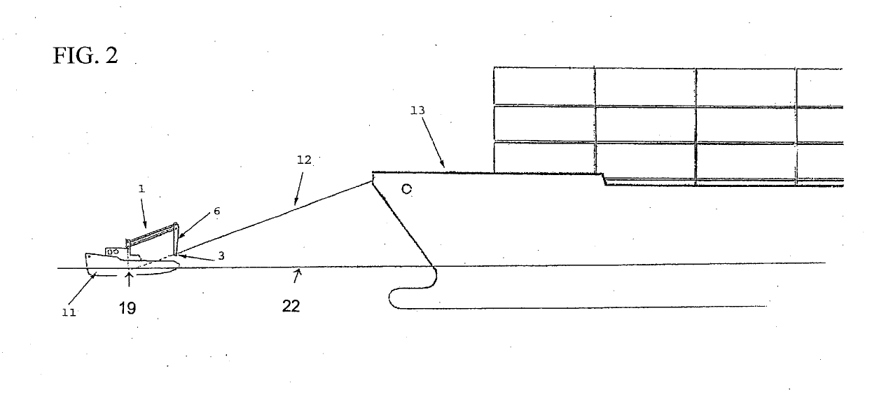

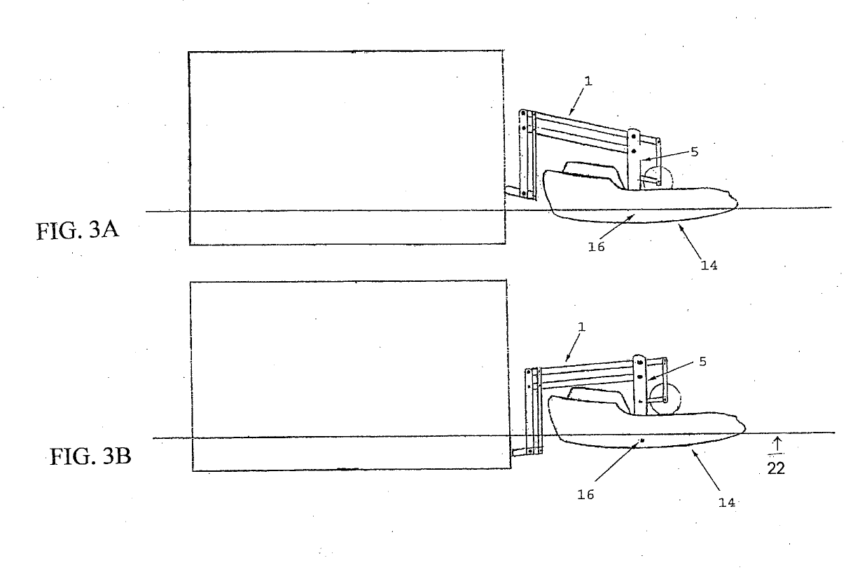

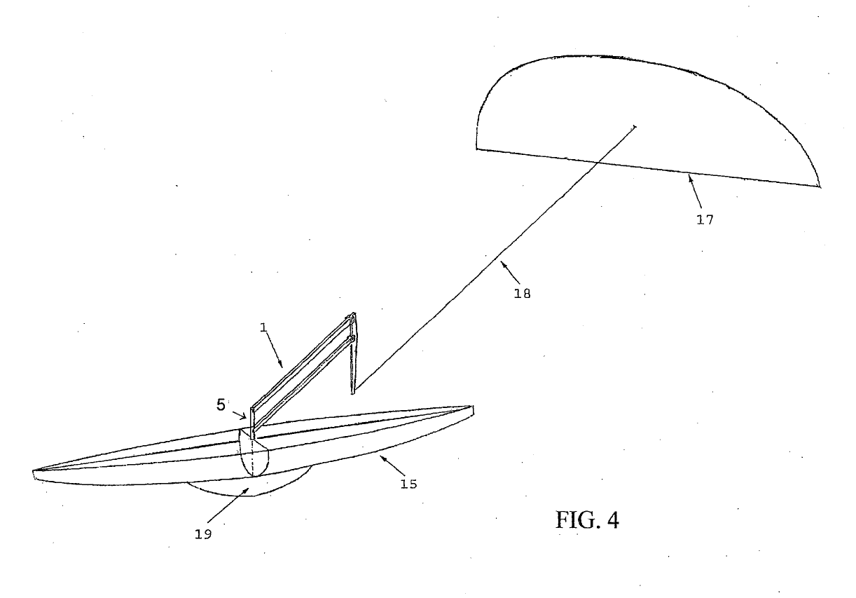

Reference is now made to FIG. 2 showing an embodiment of the vessel 11 of the invention provided with the mechanism 1 of the invention that has been extensively discussed herein-above. At the side of the movable extremity 3, the second arm 6 of the mechanism 1 is connected with a containership 13 by means of a tow line 12. The forces that are exerted by the vessel or towboat 11 on the containership 13 appear to have their origin in a point 19 within the towboat 11 that lies below the water level 22. Said point 19 is the crossing point of the extension of the tow line 12 and the extension of the first arm 5 below deck level of the towboat 11. Thus when the towboat 11 exerts a pulling force on the containership 13, it is possible with a proper choice of the length of the first arm 5 in relation to the length of the second arm 6, to arrange that said point 19 is at a level within the tow boat 11 at which the inclination of the towboat 11 in the water is hardly affected and can be maintained optimal or near to optimal.

FIGS. 3A and 3B show the embodiment of the vessel 14 of the invention operating as a push tug. In this embodiment the mechanism 1 is arranged such that a pushing force exerted by the push tug 14 appears to originate from a position 16 within said push tug 14, preferably below the water level 22.

FIG. 4 shows another embodiment of the vessel 15 of the invention in which the mechanism 1 connects to a kite 17. In this embodiment the forces exerted by the kite 17 on the vessel 15 through the cable 18 are deemed to act on the position 19 within the vessel 15. The arrangement of the mechanism 1 can be such that this position 19 coincides with a preferred part of the vessel, such as its center of lateral resistance or the point that is level with the line along which the vessel experiences its highest drag-resistance. Again this position 19 lies on the cross point of the extension of the cable 18 and the extension of the first arm 5 of the mechanism 1.

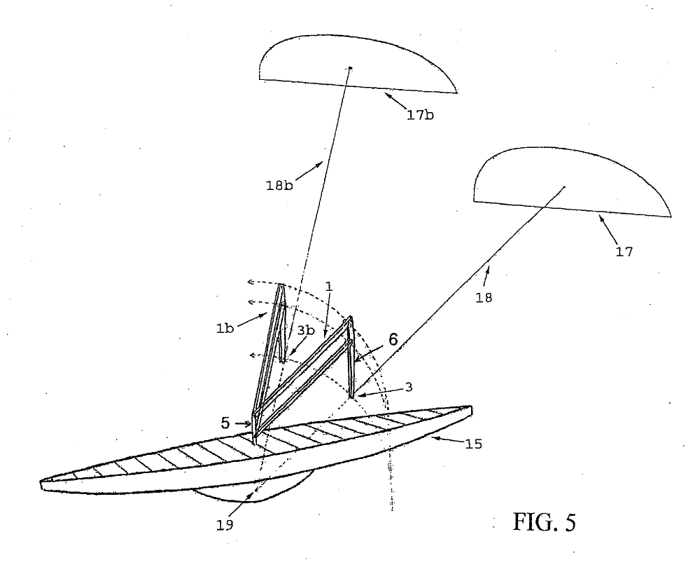

FIG. 5 shows again the embodiment of FIG. 4 wherein the kite 17 provides pulling forces through a rope or cable 18 to the vessel 15 of the invention. This FIG. 5 also shows that the mechanism 1 is arranged to be able to rotate around the longitudinal axes of the first arm 5 which is mounted on the vessel 15, enabling that a displacement of the kite in the horizontal plane can be simply followed.

FIG. 5 furthermore shows that the mechanism 1 can simply follow the movements of the kite 17 when it assumes for instance position 17b at a higher level than an earlier position 17. In order to arrange that in both situations the forces acting on the vessel 15 are deemed to act on said position 19 within the vessel, the mechanism 1 is arranged to automatically adjust to the higher position of the kite 17b by a corresponding repositioning of the movable extremity 3 of the second arm 6 to the position 3b. Again in position 3b of the movable extremity of the second arm 6, the crossing point of the extension of rope 18b and the extension of the first arm 5 is and remains said position 19 within the vessel 15.

Although the mechanism 1 is shown in the figures as a parallellogram-mechanism, there is no requirement that necessitates the use of such a parallelogram. The only requirement is that the mechanism provided on the vessel of the invention answers to the appended claims. The appended claims may therefore not be construed as limited by the provided examples which are merely intended as embodiments that are suitable for elucidating the appended claims.

What is claimed is:

1. Vessel provided with a mechanism having a first arm which is positioned thereon, and a second arm having a movable extremity distant from the first arm, wherein said first arm and said second arm are connected to each other with at least one link having hinges on opposite sides of said at least one link that connect said link or links to the first arm and second arm respectively, wherein the length of the second arm is selected so as to arrange that when the hinges on the opposite sides of said links are at the same horizontal level, the movable extremity of the second arm is level with a predetermined position within the vessel.

2. Vessel according to claim 1, wherein the predetermined position within the vessel coincides with a selected one of the group consisting of the vessel's center of lateral resistance and a point on the line along which the vessel experiences its highest drag-resistance.

3. Vessel according to claim 1, wherein the mechanism is rotatable around a longitudinal body axis of the first arm of the mechanism.

4. Vessel according to claim 1, wherein one or more links of the mechanism that are intended for transferring a pulling force are flexible.

5. Vessel according to claim 1, wherein the mechanism has a counterweight and/or a spring based balancing system and/or a hydraulic balancing system.

6. Vessel according to claim 1, wherein the length of the first arm and/or second arm is adjustable.

7. Method for transferring a force to or from a vessel by application of a mechanism having a first arm that is rotatably positioned on the vessel, and which mechanism has a second arm distant from the first arm which occupies an orientation with respect to said first arm which at least in part is determined by said force, comprising selecting the second arm to be of greater length than the first arm and causing that the force acts on the vessel or originates from the vessel on or from a point within the vessel below the position where the first arm is mounted on the vessel.

8. Method according to claim 7, wherein the first arm and/or the second arm is adjusted to a desired length.

9. Mechanism that makes it possible to have a connecting point for forces outside of a body, while the acting point of the exerted forces is within the body.
